(19) United States
(12) Patent Application Publication
(10) Pub. No.: US 2024/0328861 A1
(43) Pub. Date: Oct. 3, 2024

(54) INFRARED-IDENTIFIABLE WEARABLE ARTICLES

(71) Applicant: ZEBRA TECHNOLOGIES CORPORATION, Lincolnshire, IL (US)

(72) Inventors: Anders Gustafsson, Lincolnshire, IL (US); James J. O'Hagan, McHenry, IL (US); Gene A. Hofer, Lake Zurich, IL (US); Mohannad Abdo, Clifton, NJ (US)

(21) Appl. No.: 18/128,920

(22) Filed: Mar. 30, 2023

(51) Int. Cl. G01J 5/02; G01J 5/00; G01J 5/04

(52) U.S. Cl. CPC G01J 5/0265; G01J 5/0025; G01J 5/046

(57) ABSTRACT

An article for association with a target generating infrared radiation includes: a body defining: (i) a first portion having a first opacity to the infrared radiation, and (ii) a second portion having a second opacity to the infrared radiation smaller than the first opacity; wherein the first and second portions define a mask for infrared radiation generated by the target, the mask corresponding to a predefined identifier of the article.

### BACKGROUND

Machine-readable data carriers such as barcodes can be deployed to identify target objects, e.g., from images captured by barcode scanning devices. Capturing and decoding a barcode to identify an associated target object may, however, be less likely to succeed as the distance from the scanning device to the target object increases.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for target identification.

FIG. 2A is a diagram of an infrared-identifiable wearable article.

FIG. 2B is a cross-section of the article of FIG. 2A.

FIG. 2C is a diagram illustrating the appearance of the article of FIG. 2A in an infrared image.

FIG. 3A is a diagram of an infrared-identifiable wearable article.

FIG. 3B is a cross-section of the article of FIG. 3A.

FIG. 3C is a diagram illustrating the appearance of the article of FIG. 3A in an infrared image.

FIG. 4A is a diagram of an infrared-identifiable wearable article.

FIG. 4B is a cross-section of the article of FIG. 4A.

FIG. 4C is a diagram illustrating the appearance of the article of FIG. 4A in an infrared image.

FIG. 5A is a diagram of an infrared-identifiable wearable article.

FIG. 5B is a cross-section of the article of FIG. 5A.

FIG. 5C is a diagram illustrating the appearance of the article of FIG. 5A in an infrared image.

FIG. 6A is a diagram of an infrared-identifiable wearable article.

FIG. 6B is a cross-section of the article of FIG. 6A.

FIG. 6C is a diagram illustrating the appearance of the article of FIG. 6A in an infrared image.

FIG. 7A is a diagram of an infrared-identifiable wearable article.

FIG. 7B is a cross-section of the article of FIG. 7A.

FIG. 7C is a diagram illustrating the appearance of the article of FIG. 7A in an infrared image.

FIG. 8A is a diagram of an example infrared-detectable article imaged under visible light.

FIG. 8B is a diagram of another example infrared-detectable article imaged under visible light.

FIG. 9 is a diagram of further example infrared-identifiable wearable articles.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to an article for association with a target generating infrared radiation, the article comprising: a body (i) comprising a first portion having a first opacity to the infrared radiation, and (ii) defining a second portion having a second opacity to the infrared radiation smaller than the first opacity: wherein the first and second portions define a mask for infrared radiation generated by the target, the mask corresponding to a predefined identifier of the article.

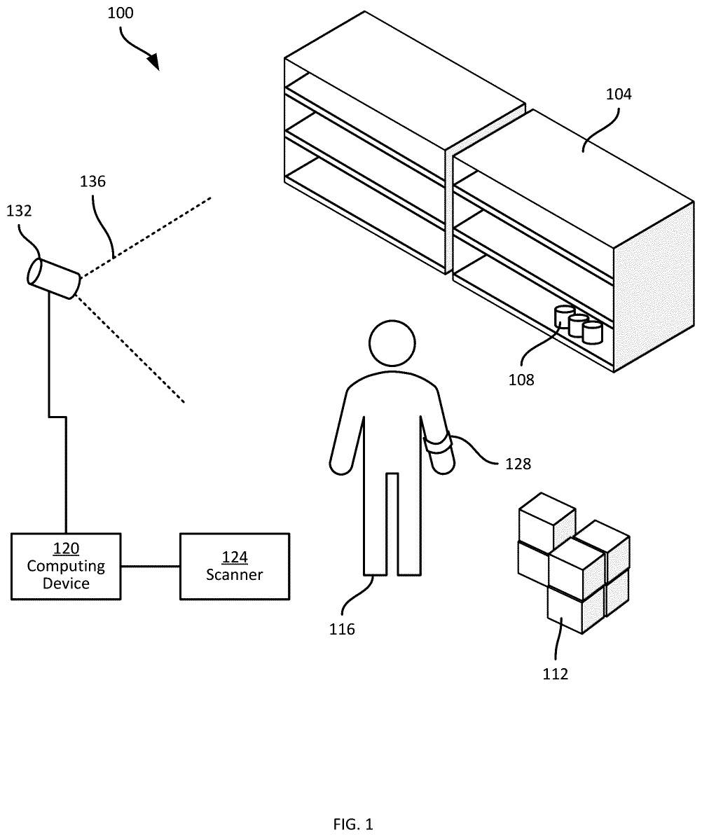

FIG. 1 illustrates a system 100 including, for example, a support structure 104 such as a shelf carrying a first set of items 108, as well as a staging area containing a second set of items 112. The system 100 can be implemented, for example, in a facility where items 108 (e.g., items of a first type) and 112 (e.g., items of a second type, such as packaging materials) are combined, e.g., in a packaging task. For example, to complete one instance of the packaging task, a worker 116 can retrieve one of the items 108 and one of the items 112 from the shelf 104 and the staging area, respectively, before combining or otherwise manipulating the retrieved items 108 and 112, and depositing the combined or otherwise manipulated items 108 and 112 in a designated location (e.g., on a conveyor, in a receptacle, or the like).

A wide variety of items 108, 112, can be handled by the worker 116, and in other examples the system 100 can include fewer types of items than the two types shown in FIG. 1, or more than the two illustrated types of items. Further, a wide variety of handling tasks may be performed by the worker 116 in addition to or instead of the packaging task mentioned above. Other example handling tasks performed by the worker 116 can include manufacturing tasks, repair tasks, inspection tasks, or the like. Such tasks can be single-stage tasks (e.g., picking an item 108 to a receptacle) or multi-stage tasks including two or more subtasks, as with the packaging task noted above. For instance, a single packaging task may include subtasks such as retrieving a box 112 from the staging area, assembling the box, picking up one of the items 108 from the shelf, placing the item in the assembled box, adding fill material to the box, obtaining a piece of tape from a nearby paper tape machine, closing the box flaps, applying the obtained tape to the box flaps to seal the box, and placing the sealed box on a cobot for movement to a shipping area of the facility.

The system 100 can include elements to monitor the performance of tasks such as the packaging task set out above. For example, the system 100 can include a computing device communicating with a reader 124, such as a barcode scanner, a radio frequency identification (RFID) reader, a magnetic stripe reader or the like. The worker 116 may carry a target identifier distinguishing the worker 116 from other workers in the facility, e.g., encoded in a data carrier such as a barcode printed or otherwise disposed on a wearable article 128 such as a wristband, memory in a radio frequency identification (RFID) tag, or a magnetic signature on a magnetic stripe laminated onto a plastic card. The target identifier may include an employee number, account identifier, or the like, that uniquely identifies the worker 116 from any other workers employed or otherwise active in the facility.

The target identifier may require many bits of data to meet various needs of an employer and/or an operator of the facility. A large employer with many workers may require many target identifiers to uniquely identify each worker, so each target identifier may require many data bits, bytes, or characters. Some facility operators may use the target identifier both for uniquely identifying the worker and also for providing electronic access to a computer system, physical access control system, or timeclock; each target identifier may require many bits to provide data appropriate for those other systems. As a result, the data carrier for the target identifier may include a barcode with multiple elements, an RFID tag with sufficient memory, or a card with a magnetic stripe or near-field communication (NFC) circuit configured to hold any of the target identifiers that may be used.

Associating a task instance with the worker 116 can be determined by the computing device 120 by, for example, capturing the data carrier via the reader 124 when the task is initiated, decoding the target identifier from the data carrier, and associating the target identifier with the task instance. Monitoring data such as the time elapsed for completing the task may be determined by the computing device 120 by saving an initial time at which the target identifier was associated with the task instance, capturing the data carrier again when the task is completed, decoding the target identifier from the second data capture event, associating the second data capture event with the initial association based on the decoded data, and calculating a time elapsed between the initial association and the subsequent data capture. Capturing the data carrier for a target identifier may involve an explicit scan operation initiated by the worker 116, (e.g., holding the article 128 close to the reader 124). Because each read operation initiated by the worker 116 consumes time, this approach may therefore be unsuitable for measuring the elapsed time for multiple tasks in a busy facility, for a complex task with multiple subtasks, or for tasks requiring the worker 116 to perform multiple actions with his hands.

To track the movements of the worker 116 during the performance of a task, e.g., for subsequent processing to detect the time elapsed for the completion of various subtasks, the system 100 can include an infrared-sensitive camera 132 oriented to provide a field of view 136 encompassing a work area in which the relevant task is performed. The camera 132 can include, for example, a sensor configured to capture long-wave infrared (LWIR) radiation and to compose an image including a plurality of pixels indicating the intensity of the IR radiation received from relative positions within the field of view 136. The camera 132 and/or the sensor may also be configured to capture other wavelengths, (e.g. visible light, medium wave infrared radiation, ultraviolet radiation) instead of or in addition to LWIR. The camera 132 can capture a stream of images and provide the images to the computing device 120, e.g., encompassing a period of time between the initiation and the completion of a task. The computing device 120 can then process one or more images to detect a worker 116 and may process the stream of images to detect movement patterns of the worker 116, associate those movement patterns with timing data, and derive subtasks completion times therefrom.

In certain scenarios, only one worker may be active in the facility so associating the worker 116 detected in the captured images with the target identifier of the worker is straightforward. In some scenarios however, a facility may include many workers each of whom is associated with a respective target identifier. In such scenarios an explicit read operation initiated by the worker 116 at the start of a task may be appropriate for associating the task instance with the target identifier of the worker as explained above. However, the presence of other workers in the field of view 136, and/or the periodic departure of the particular worker 116 from the field of view 136 may complicate the identification of the worker 116 in later images of the stream of images that may be necessary to generate analytical data about the subtasks. Solutions such as requiring all workers to socially distance themselves to ensure only one worker is within the field of view 136 of a particular camera 132 while the camera captures the stream of images and requiring the worker to initiate subsequent read operations each time he leaves or re-enters the field of view 136 may be impractical.

The article 128 therefore includes certain structural features to facilitate correctly associating a worker detected from later images of the stream of images with the worker associated with his respective target identifier at the beginning of the task. As an example, a captured stream of images may be analyzed to detect, from an initial plurality of images, a worker 116 and an article 128, to determine that no worker can be detected in a subsequent plurality of images, and to detect in a later plurality of images, a worker 116 and/or an article 128. For a worker who exits the field of view 136 for only a moment (correlated with the period when the subsequent plurality of images was captured), a simple binary detection of an article 128 from the later plurality of images may be all that is necessary to confirm that the worker performing the subtask correlated with the period when the later plurality of images was captured is the same worker detected from the initial plurality of images. This analysis may be done with image data captured by the camera 132 with a large field of view 136. As discussed below; the article 128 defines a mask for infrared radiation emitted by the worker 116 (or any other infrared-emitting identification target).

An IR camera 132 oriented to capture an image from a field of view 136 comprising the worker 116 wearing an article 128 may capture an image of the masked infrared radiation at approximately the same time as the reader 124 reads the data carrier and captures the target identifier of the worker 116. The computing device 120 may then detect a pattern of the masked infrared radiation and associate that pattern with the target identifier. In an embodiment, the pattern corresponds to a predefined identifier of the article 128, e.g., stored at the computing device 120. The predefined article identifier need not match the target identifier of the worker 116. For example, articles 128 can be distributed to a plurality of workers 116 in the facility, each having an article identifier selected from a set of article identifiers smaller than the set of target identifiers assigned to the workers.

As discussed below; the article 128 defines a mask for target-emitted infrared radiation by including distinct portions with different opacities to infrared radiation. Some portions of the article 128 can have a first opacity to infrared radiation, while other portions of the article 128 can have a second opacity to infrared radiation, smaller than the first opacity. When the article 128 is worn by the worker 116, the portions with the second opacity allow the passage of a greater proportion of infrared radiation generated by the worker 116 (e.g., as body heat) than allowed by portions of the article 128 with the first opacity. The differential passage of infrared radiation from the worker 116 through the article 128 results in different intensities of the infrared radiation arriving at the camera 132, resulting in shapes and/or patterns captured as images by the camera 132. Those images may then be analyzed to detect the shape and/or pattern resulting from the infrared radiation emitted by the worker 116 as masked by the article 128. The computing device 120 can be configured to distinguish a worker wearing the patterned masking article 128 from other workers (e.g., workers wearing articles 128 with different patterns or not wearing a masking article 128) based on shapes and/or patterns detected in images captured by the camera 132, and thus track movements of the worker 116 over sequences of images.

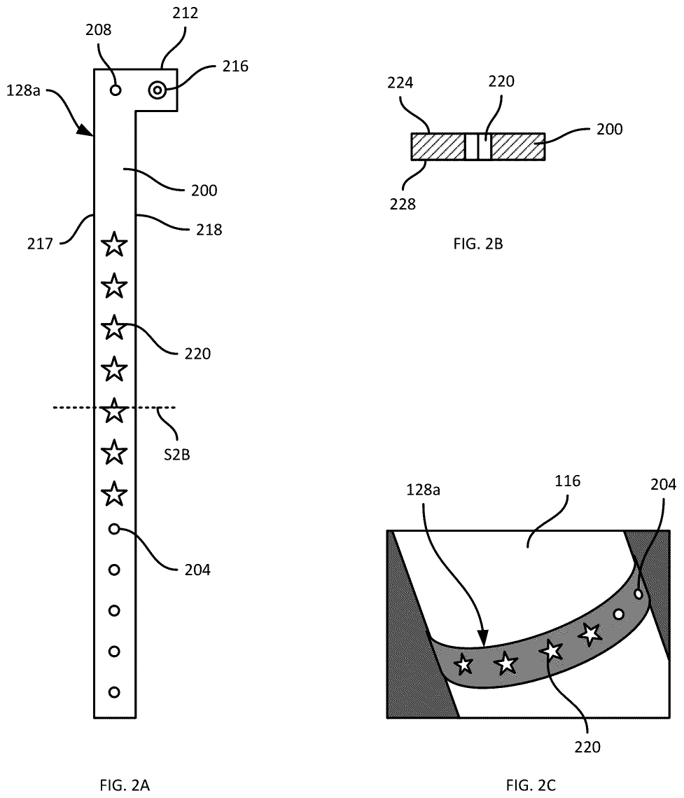

Turning to FIG. 2A, FIG. 2B, and FIG. 2C, an example article 128a is illustrated. In the illustrated example, the article 128a is a wristband, although various other articles can also implement the differential passage of target-generated infrared radiation discussed above. The article 128a includes a body 200 wearable by an identification target such as a human subject, such as the worker 116. For example, the body 200 can include a clasping mechanism defined by a set of adjustment holes 204 extending through the body 200, a locking hole 208, and a tab 212 carrying a fastener 216. The body 200 can be shaped into a loop (e.g., around a wrist of the worker 116), and the locking hole 208 can be aligned with one of the adjustment holes 204, following which the tab 212 can be folded over to push the fastener 216 through an adjustment hole 204 aligned with the locking hole 208. In an embodiment as drawn, the body 200 comprises a substrate cut to define a strip of a generally rectangular shape defined by two straight parallel sides 217 and 218 with the adjustment holes 204 extending through the body 200 along an imaginary adjustment hole line parallel to and equidistant from the straight parallel sides 217 and 218. In an embodiment, some or all of the adjustment holes 204 may be offset to one side of the equidistant line, or some of the adjustment holes may be offset while some of the adjustment holes are along the equidistant line. In an embodiment, at least one of the sides 217, 218 defining the strip is a contour that is not straight and is instead wavy or jagged, providing an IR mask to produce an identifiable pattern in the image captured by the IR camera 132.

In an embodiment, the body 200 includes at least one opening 220, in addition to the set of adjustment hole openings 204. That is, the opening 220 can be distinct from the clasping mechanism of the article 128. The body 200, which can comprise a core material such as a polymer, a textile, or the like, has a first opacity to infrared radiation. The opening 220 has a second opacity to infrared radiation that is smaller than the opacity of the core material. For example, as shown in FIG. 2B (which illustrates the cross section S2B labelled in FIG. 2A), the opening 220 extends from a first surface 224 to a second surface 228 of the body 200, and therefore has a substantially null opacity to infrared radiation.

The openings 220 are shown as having star shapes but can have any of a wide variety of shapes in some examples. For example, in a given facility, a plurality of articles 128 can be distributed among workers 116, each article 128 having openings 220 with one of a set of shapes that are distinguishable from each other in images captured by the camera 132. For example, some articles 128 can have star-shaped openings 220 as shown in FIG. 2A, while other articles 128 can have triangular openings 220, square openings, or the like. In an embodiment, a first article 128 may have a first pattern of openings (e.g. star, star, triangle, star, star, triangle), and a second article 128 may have a second pattern of openings (e.g. star, triangle, star, triangle, star, triangle).

FIG. 2C illustrates the article 128a as imaged by the camera 132 when worn by the worker 116. The image shown in FIG. 2C can correspond to the entire field of view 136, but can also correspond to a portion of the field of view 136 (e.g., to a portion of an image captured by the camera 132, with a remainder of the image omitted from FIG. 2C). As seen in FIG. 2C, the skin of the worker 116 appears bright, as do any openings 204 and 220 that are within line-of-sight of the camera 132. The core material of the body 200, however, appears darker, as a result of the increased opacity to infrared radiation of the core material. The difference in opacity between the openings 220 and the core material, in other words, defines a mask for infrared radiation emitted by the worker 116, from which the shapes of the openings 220 can be detected in images captured by the camera 132. For example, the computing device 120 may store a predefined identifier corresponding to the article 128a, and can associate that predefined identifier with any portion of an image in which at least one star-shaped opening 220 is detected. If that predefined identifier is also associated with a target identifier of a worker, the worker may then also be associated with the portion of the image.

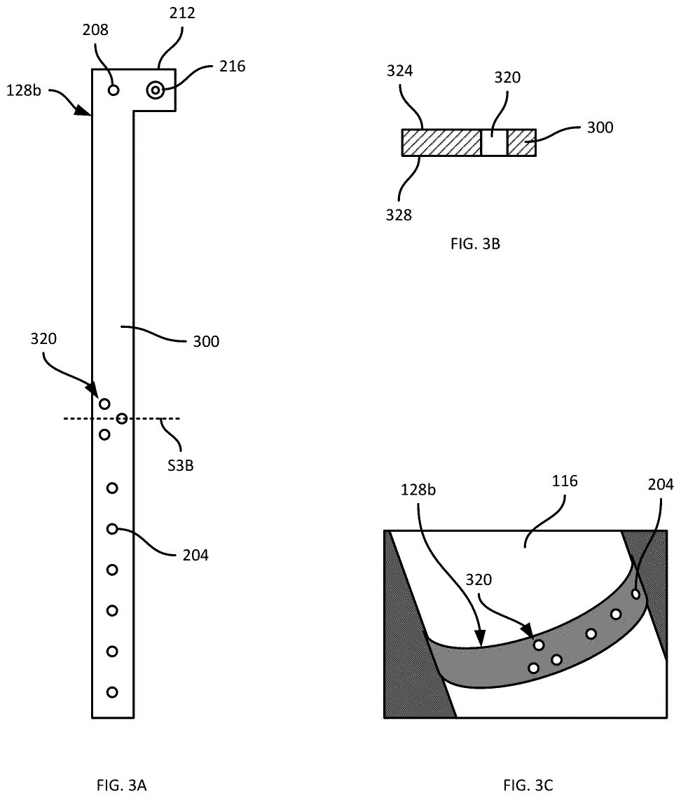

FIG. 3A, FIG. 3B, and FIG. 3C illustrate another example article 128b, including a clasping mechanism as discussed above in connection with FIG. 2A. The article 128b also includes a body 300 that defines, in addition to the openings 204, a set of openings 320 extending from a first surface 324 to a second surface 328 of the body 300, as shown in FIG. 3B (which illustrates the section S3B). In the present example, the set of openings 320 are circular openings, arranged in a triangular configuration. The openings of the set 320 need not have the same shape as one another, in some examples. Various numbers and arrangements of the openings 320 can also be implemented. Whereas detection of any one of the openings 220 of the article 128a can correspond to a predefined identifier of the article 128a, identification of the article 128b can be dependent on detection of the set of openings 320 as a whole. For example, detection of a single circular opening in an image captured by the camera 132 may not result in identification of the article 128b, while detection of three circular openings forming a triangular shape, as shown in FIG. 3C, may result in a successful identification of the article 128b.

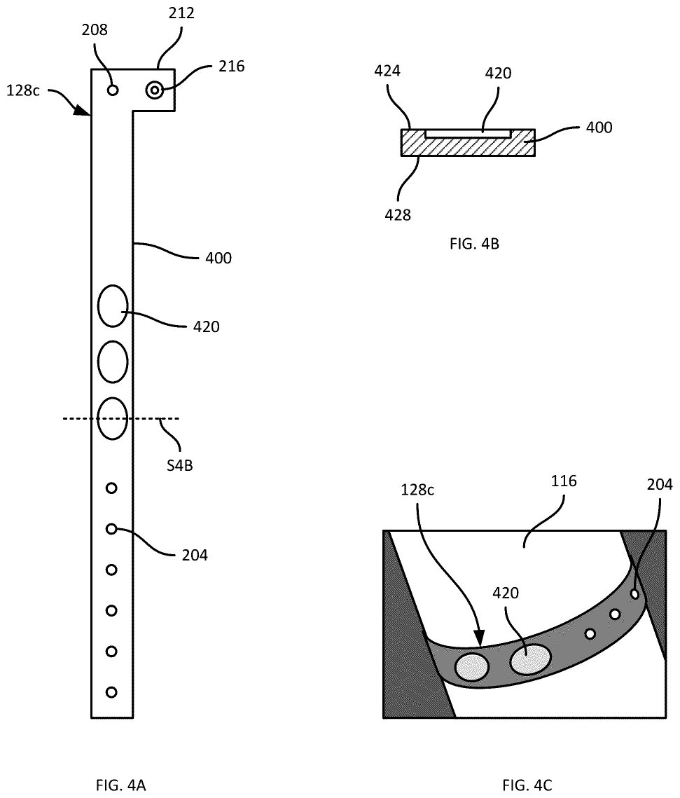

In further examples, as shown in FIG. 4A, FIG. 4B, and FIG. 4C, differing opacities can be defined by varying a thickness of the article 128. FIG. 4A illustrates an article 128c, e.g., in the form of a wristband, having a body 400 and a clasping mechanism as set out in connection with FIG. 2A. The body 200 includes regions 420 (three in the illustrated example, although any number, arrangement, and shape of regions can be employed in other examples) where a core material of the body 400 has a reduced thickness.

As seen in FIG. 4B, which illustrates a cross-section S4B of the body 400, the regions 420 do not extend through the body 400 from a surface 424 to a surface 428. Instead, in this example, the regions 420 extend from the surface 424 into the body 400, but are not open at the opposing surface 428. FIG. 4C illustrates the article 128c as captured by the camera 132. The reduced thickness of the body 400 at the regions 420 gives the regions 420 reduced opacity to infrared radiation emitted by the worker 116, such that an imaged brightness of the regions 420 is greater than an imaged brightness of a remainder of the body 400 (with the exception of the openings 204). The presence and shape of one or more regions 420 can therefore be detected in an image, based on the contrast between the region 420 and the surrounding body 400.

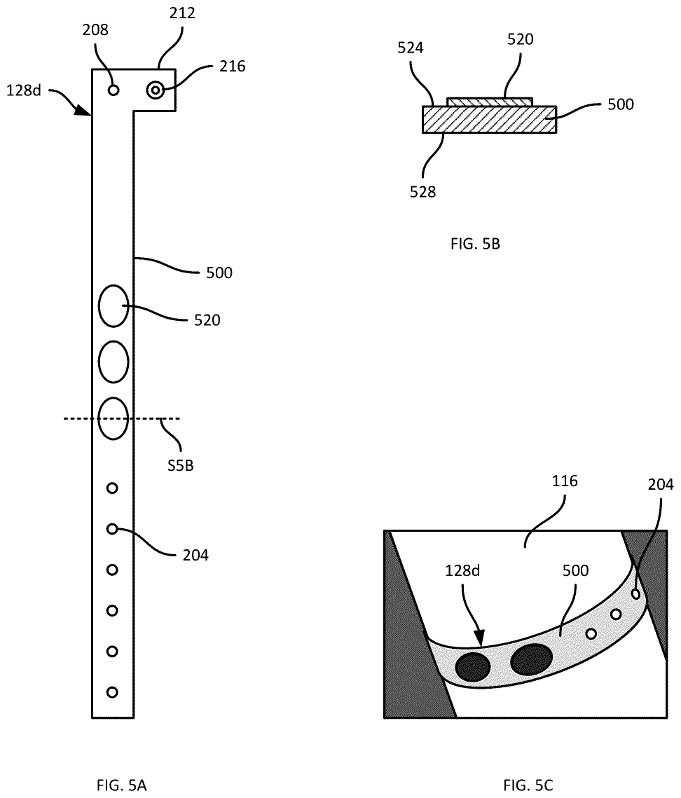

In further examples, as shown in FIG. 5A, FIG. 5B, and FIG. 5C, the core material of the article 128 can define the second portion (having a lower opacity to infrared radiation), while additional elements of the article 128 can define the first portion (having a higher opacity). FIG. 5A illustrates an article 128d having a body 500 formed from a core material with that is translucent or transparent to infrared radiation. In addition to the clasping mechanism defined by the openings 204 and 208, the tab 212, and the fastener 216, the body 500 includes at least one layer 520 of a second material, e.g., disposed on a first surface 524 of the body 500, as shown in FIG. 5B. (which depicts a section S5B labelled in FIG. 5A). In other examples, the layer(s) 520 can be disposed on a second surface 528 instead of or in addition to the first surface 524.

The second material has a greater opacity to infrared radiation than the core material forming the remainder of the body 500. For example, the second material can include toner (e.g., laser printer toner), thermal transfer ink, or the like. The second material of the layer(s) 520 need not be detectable under visible light, but reflects, refracts, and/or absorbs infrared radiation emitted by the worker 116. As shown in FIG. 5C, therefore, images of the article 128d captured by the camera 132 reveal the body 500 as being translucent or transparent (e.g., having low contrast relative to the worker 116). The layer(s) 520 exhibit greater contrast with the body 500 and the worker 116, due to the greater opacity to infrared radiation of the second material. The shapes, orientations, and relative positions of the layer(s) 520 can vary widely between articles 128, as noted in connection with the articles 128a and 128b.

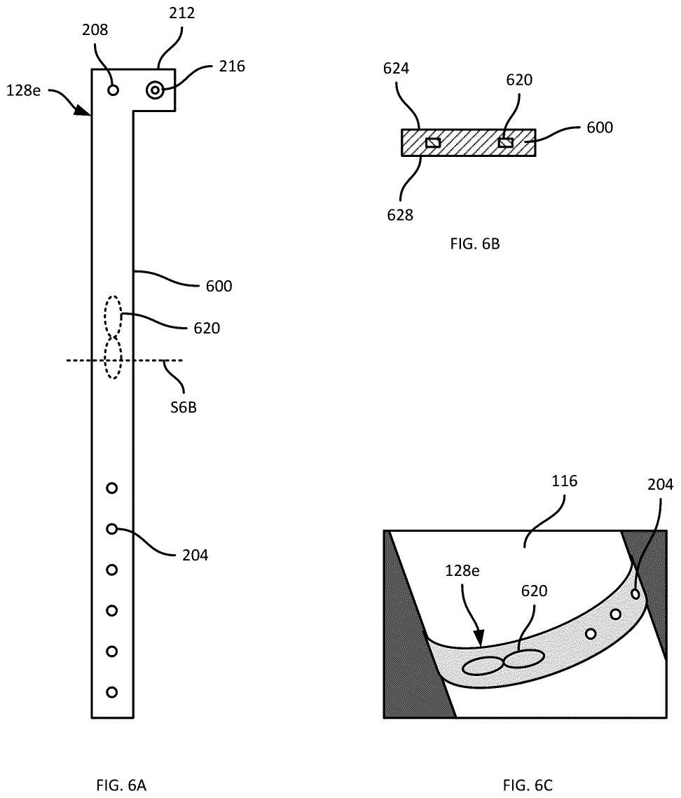

In some examples, the second material forming the layer(s) 520 can be embedded within the body 500. For example, FIG. 6A illustrates an article 128e in which a body 600 defines the second portion, and an embedded component 620 defines the first portion. The embedded component 620, in other words, has a greater opacity than the core material of the body 600. As shown in the cross section S6B, illustrated in FIG. 6B, the component 620 is disposed within the body 600, between first and second surfaces 624 and 628. The component 620 may therefore not be detectable under visible light. However, the greater opacity of the component 620 to infrared radiation than the remainder of the body 600 can result, as shown in FIG. 6C, in the component 620 being detectable in an infrared image of the article 128e captured by the camera 132.

The layer(s) 520 and the component 620 can be formed from any of a variety of materials, including polymers, inks, films, textiles, and the like. For embedded materials such as the component 620, beads, granular material, or the like, may be employed. In some examples, the component 620 can be implemented as a data carrier, e.g., in the form of an RFID device. For example, the component 620 can include a metallic antenna defining the two loops shown in FIGS. 6A and 6C. In such examples, the article 128e can also include one or more layers 520, positioned relative to the component 620 so as to define an infrared mask distinct from other articles 128. That is, the component 620 and the layer(s) 520 together can define the infrared mask corresponding to a predefined article identifier detectable by the computing device 120.

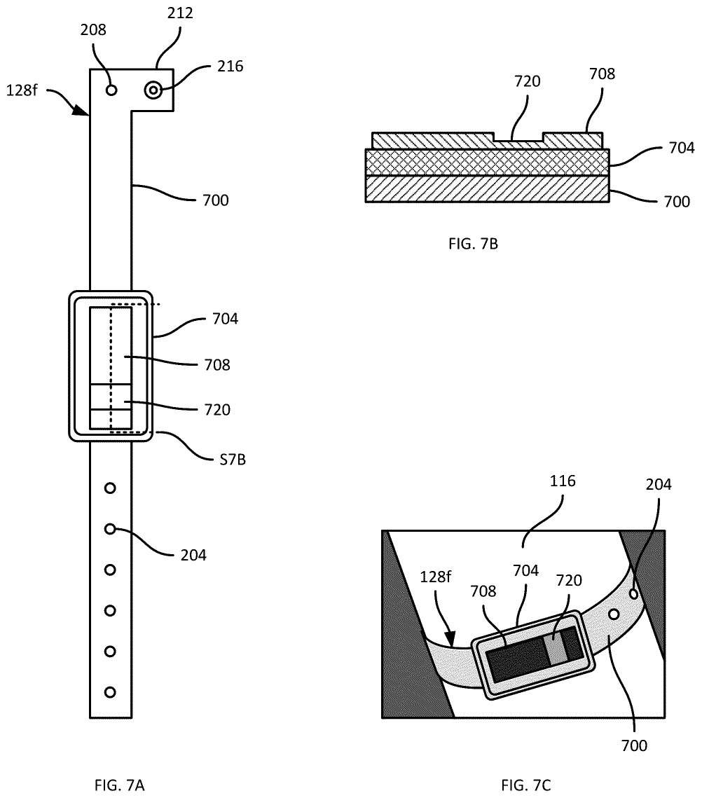

In further examples, as shown in FIG. 7A, FIG. 7B, and FIG. 7C, the first and second portions with different opacities to infrared radiation can be defined by a coating of material with varying thickness. For example, FIG. 7A illustrates an article 128f including a body 700 carrying a tag 704 (e.g., affixed to the body 700 via adhesive or the like). In other examples, the tag 704 can be omitted and the features discussed below in connection with the tag 704 can be implemented directly on the body 700.

The tag 704 can include a coating 708 of a second material with a greater opacity to infrared radiation than the core material forming the body 700. The coating 708 can include one or more regions with a first thickness, and one or more regions 720 with a second thickness smaller than the first thickness, as shown in the cross section S7B illustrated in FIG. 7B.

The regions of the coating 708 with the first thickness, as shown in FIG. 7C, are substantially opaque to infrared radiation, while the regions 720 (as well as the underlying body 700 and tag 704) are less opaque to infrared radiation and therefore appear lighter in images captured by the camera 132. Although two coating thicknesses are illustrated in FIG. 7B, in other examples the coating 708 can include more than two distinct thicknesses. In some examples, the regions 720, as well as other regions of the coating 708 with other thicknesses, can be arranged to encode data, e.g., in the form of an Ultracode or other barcode. In an embodiment, a barcode encoding a target identifier using a visibly contrasting pattern may be printed on the body of the article 128 to facilitate identification of the worker 116 by the reader 124, while the ink or toner used to print the data carrier on the article 128 provides a region of greater opacity to infrared radiation, thus producing a detectable pattern in images captured by the IR camera 132 that may be used to differentiate workers within a field of view 136 of the camera. As explained above, the mask may provide a sufficiently unique detectable pattern in the captured IR images without necessarily providing a decodable target identifier in the captured IR images, even if a captured visible image of the barcode by the reader 124 does provide sufficient resolution to decode the target identifier from the barcode.

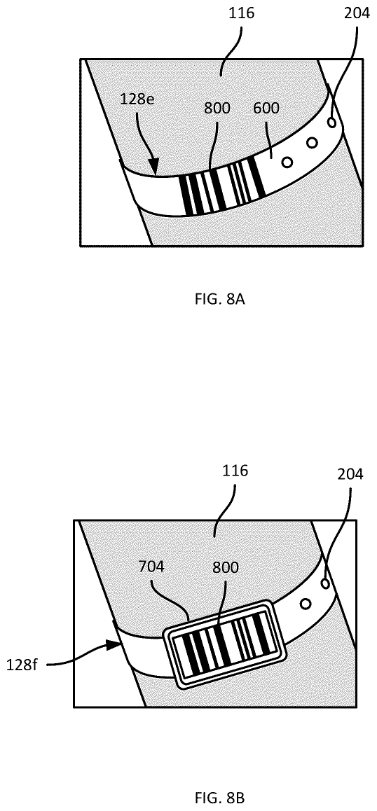

Turning to FIGS. 8A and 8B, the articles 128e and 128f, respectively, are illustrated as imaged under visible light. As shown in FIG. 8A, the article 128e can include a data carrier 800, such as a barcode, on the body 600. The data carrier 800 can be applied to the body 600 via any suitable printing process. As will be apparent from FIG. 8A and FIGS. 6A, 6B, and 6C, the component 620 is not imaged under visible light, and the data carrier 800 is not imaged under infrared light. That is, the material used to apply the data carrier can have a third opacity to infrared radiation, that is smaller than the opacity of the second portion of the article 128. For example, the pigments used to apply the data carrier 800 can be substantially transparent to infrared radiation (e.g., inks or coatings including direct thermal pigments). The data carrier 800 can therefore be overlaid on the component 620, without interfering with detectability by the camera 132 of the pattern caused by component 620 blocking infrared radiation generated by the worker 116.

FIG. 8B illustrates the article 128f under visible light, revealing the data carrier applied to the tag 704. For example, the data carrier 800 can be printed over the coating 708 in some examples. In other examples, the coating 708 can define the data carrier 800, and the material of the coating 708 can be selected to have distinct appearances under infrared and visible light.

In an embodiment, a single sheet including a plurality of wristbands may be configured for a plurality of workers in a facility, such as a long web with multiple wristbands connected end to end, or a page or wide web with multiple wristbands arranged side to side. A first wristband of the plurality of wristbands may include a first masking pattern, such as star-shaped adjustment holes, while a second wristband of the plurality of wristbands may include a second masking pattern, such as triangle-shaped adjustment holes. Such an arrangement may facilitate providing different masking patterns to different workers receiving wristbands at about the same time, increasing the likelihood that two workers in same field of view 136 may be easily differentiated within the stream of images captured by the IR camera 132. As explained above, varying other aspects of the wristbands within the plurality of wristbands comprising the single sheet would provide the same benefit. In an embodiment, the single sheet may be further configured for printing, such as a page for laser printing, a long web for thermal printing, or a form sized for a print media cartridge. In this way, the plurality of wristbands may each be printed with a unique data carrier encoding a target identifier associated with a worker who will wear the wristband.

In an embodiment, a printer deployed in the facility is loaded with wristbands of various shapes. When each worker 116 signs in for a shift, a wristband is printed for the worker. The wristband comprises a printable body, such as a paper, polyester, or Tyvek substrate coated with direct thermal dye or finished to receive toner or ink applied in the printer. The wristband has a shape that is characterized by a type of article, a multi-bit data string that corresponds to the shape of the wristband, such as a star or triangle cutout as explained below, or a straight, wavy, or jagged side. A supply of wristbands is loaded into the printer, e.g., as a spool comprising a core-mounted web of material, a cartridge holding wristbands, or a tray holding sheets of wristbands. The printer may be configured to identify the type of article being printed, such as implementing an optical sensor to detect the shape, or an RF sensor to read the type of article from an RFID chip or NFC circuit associated with the cartridge, spool, or media supply. When the worker signs in for a shift, a target identifier associated with the worker, such as an employee number, is communicated to the printer. The printer encodes the target identifier into a data carrier, produces the wristband, associates the target identifier with the type of article, and communicates the associated data to a computing device 120. Depending on the features of the printer, the target identifier could be encoded into a barcode and printed on the wristband, the target identifier could be encoded into RFID tag data and stored in an RFID tag, the target identifier could be magnetically encoded onto a magnetic stripe of a plastic card. The associated data may then be used by the computing device to facilitate identifying the worker based at least partially on the type of article he has been issued as discussed herein.

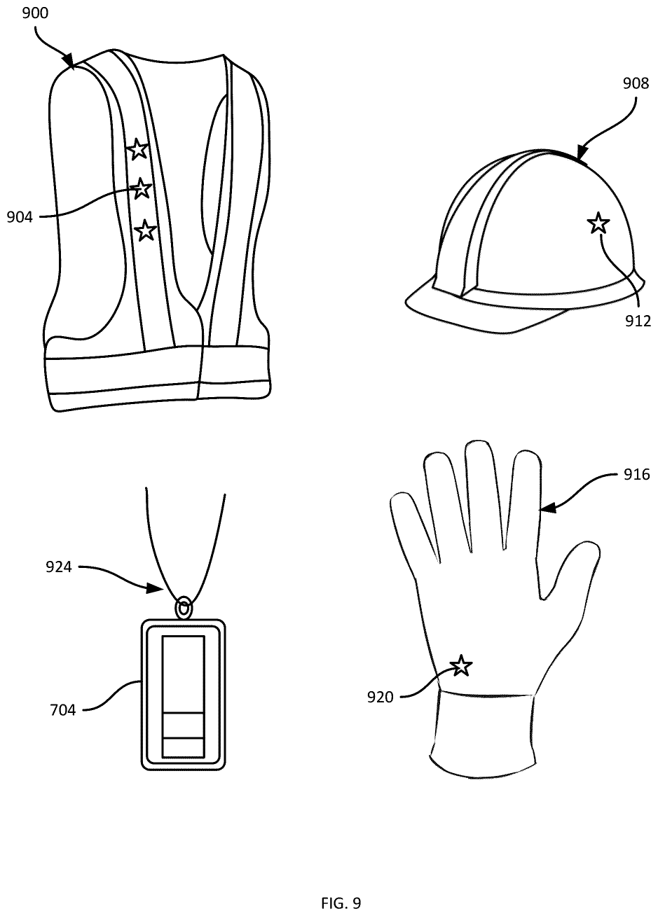

Although the articles 128 discussed above are wristbands, a variety of other articles can also implement infrared-detectable features. For example, turning to FIG. 9, additional examples of wearable articles including portions with differential infrared opacity are shown. The articles shown in FIG. 9 includes a garment 900 such as a safety vest, including one or more portions 904 with reduced infrared opacity. For example, the portions 904 can include openings, regions with reduced material thickness, or the like, as discussed in connection with any of the articles 128a to 128f.

FIG. 9 also illustrates a further article 908, such as headwear (e.g., a hard hat, although head bands and other headwear are also contemplated) including one or more portions 912 with reduced infrared opacity. In addition, FIG. 9 illustrates a glove 916 with one or more portions 920 with reduced infrared opacity, and a lanyard 924 (e.g., configured to be worn around a neck of the worker 116) carrying the tag 704.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”: “one or more of A, B, and C”: “at least one of A, B, or C”: “one or more of A, B, or C”. Unless expressly indicated otherwise, the above expressions encompass any combination of A and/or B and/or C.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An article for association with a target generating infrared radiation, the article comprising:
a body:
(i) comprising a first portion having a first opacity to the infrared radiation and
(ii) defining a second portion having a second opacity to the infrared radiation smaller than the first opacity;
wherein the first and second portions define a mask for infrared radiation generated by the target, the mask corresponding to a predefined identifier of the article.

2. The article of claim 1, wherein the target includes a human subject.

3. The article of claim 1, wherein the body is selected from a group comprising: a wristband, a glove, headwear, a vest, and a lanyard.

4. The article of claim 1, wherein the body comprises a core material defining the first portion, the body having an opening therethrough defining the second portion.

5. The article of claim 4, wherein a shape of the opening corresponds to the predefined identifier.

6. The article of claim 4, wherein the body includes a plurality of openings therethrough defining the second portion.

7. The article of claim 6, wherein relative positions of the openings correspond to the predefined identifier.

8. The article of claim 4, further comprising a clasping mechanism distinct from the opening.

9. The article of claim 1, wherein the body comprises:
a core material having a first region with a first thickness defining the first portion, and
a second region with a second thickness defining the second portion.

10. The article of claim 1, wherein the body comprises:
a core material defining the second portion; and
a second material having a greater infrared opacity than the core material, the second material defining the first portion.

11. The article of claim 10, wherein a layer of the second material is embedded in the core material.

12. The article of claim 10, wherein the second material is deposited on an outer surface of the core material.

13. The article of claim 12, wherein the second material includes at least one of a textile material, or a printed material.

14. The article of claim 1, wherein the body comprises:
a core material; and
a layer of a second material having a first region with a first thickness defining the first portion, and a second region with a second thickness defining the second portion, the second material comprising a thermalchromic dye configured to change color when exposed to heat.

15. The article of claim 1, further comprising a data carrier including a target identifier corresponding to the identification target, the target identifier being distinct from the predefined identifier of the article.

16. The article of claim 15, wherein the data carrier comprises a layer overlaid on the second portion of the body, wherein the layer has a third opacity to the infrared radiation that is equal to or smaller than the second opacity.

17. The article of claim 16, wherein the data carrier includes a barcode.

18. The article of claim 15, wherein the body includes a core material; and
wherein the data carrier includes a radio-frequency identification (RFID) device embedded in the core material.

19. The article of claim 18, wherein the body defines the second portion, and the RFID device defines the first portion.

20. The article of claim 1, wherein a contour of the first portion corresponds to the predefined identifier.
